(19) United States
(12) Patent Application Publication
(10) Pub. No.: US 2008/0214145 A1
(43) Pub. Date: Sep. 4, 2008

(54) INTELLIGENT GROUP MEDIA REPRESENTATION

(75) Inventors: Jason N. Howard, Alpharetta, GA (US); Thomas J. Weigert, Palatine, IL (US); Thomas S. Babin, Lake Zurich, IL (US); Sergey N. Baranov, St. Petersburg (RU); Yaxin Zhang, Shanghai (CN); Chung Kwang Chou, Plantation, FL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/681,763

(22) Filed: Mar. 3, 2007

(51) Int. Cl. H04Q 7/22

(52) U.S. Cl. 455/412.1

(57) ABSTRACT

A method, apparatus, and electronic device for optimizing a media presentation to a group. A memory may store a personal media user profile for a user. A processor may create a group media user profile from the personal media user profile and associated individual media user profiles. A network interface may send a request to a digital media content source for a set of digital media content with a digital media content profile that matches the group media user profile.

### FIELD OF THE INVENTION

The present invention relates to a method and system for downloading content using mobile telecommunication devices. The present invention further relates to using a group profile to choose the optimum content for the group.

### INTRODUCTION

Modern mobile telecommunications devices, such as cellular telephones, may download a variety of media content. This media content may include such media types as text, pictures, audio, video, and other types of media. The media content may be any of a variety of formats, such as standards provided by Moving Picture Experts Group (MPEG) (Including MPEG 1, Layer 3 (MP3)), standards provided by Joint Photographic Experts Group (JPEG), Portable Document Format (PDF), and others.

Often, the media content may be downloaded for more than one user. Each of these users may have different tastes, as well as different media presentation devices that operate on different formats and with different capabilities. Media that may be executable by one member of the group may not be executed by the other members. Further, a group member's taste in media may not be universal among the group.

### SUMMARY OF THE INVENTION

A method, apparatus, and electronic device for optimizing a media presentation to a group. A memory may store a personal media user profile for a user. A processor may create a group media user profile from the personal media user profile and associated individual media user profiles. A network interface may send a request to a digital media content source for a set of digital media content with a digital media content profile that matches the group media user profile.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a network for downloading digital media content to a mobile telecommunications device.

FIG. 2 illustrates in a block diagram a generic user profile that may be used by a mobile telecommunications device in selecting digital media content.

FIG. 3 illustrates in a flowchart one embodiment of a method of using a group media user profile to obtain digital media content.

FIG. 4 illustrates a possible configuration of a computing system to act as a mobile telecommunications apparatus or electronic device to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any type of computer, mobile device, or wireless communication device.

A method, apparatus, and electronic device for optimizing a media presentation to a group. A memory may store a personal media user profile for a user. A processor may create a group media user profile from the personal media user profile and associated individual media user profiles. A network interface may send a request to a digital media content source for a set of digital media content with a digital media content profile that matches the group media user profile.

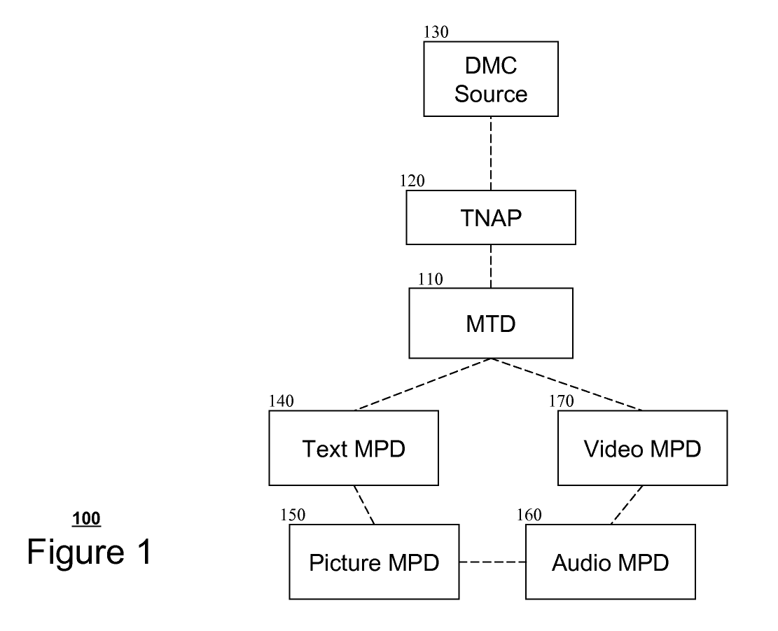

FIG. 1 illustrates in a block diagram one embodiment of a network 100 for downloading digital media content (DMC) to a mobile telecommunications device (MTD). A MTD 110 is a mobile apparatus or electronic device that may perform a telecommunications function, such as a cellular telephone, laptop computer, or other communications device. The MTD 110 may access a network through a telecommunications network access point (TNAP) 120, such as a telephone cell. The MTD 110 may download a DMC from a DMC source 130, such as a website, or have media content loaded onto it via a removable data storage medium. The DMC may be text, picture, audio, video, or some other form of media. The DMC may be in any number of formats, such as standards provided by Moving Picture Experts Group (MPEG) (Including MPEG 1, Layer 3 (MP3)), standards provided by Joint Photographic Experts Group (JPEG), Portable Document Format (PDF), and other standards. Multiple DMC sources 130 may be available to provide DMC to the MTD 110.

The MTD 110 may identify any number of media presentation devices (MPDs) for displaying many different types of media. Each of the MPDs may themselves be a mobile telecommunications device. The MTD 110 may enjoy a primary status in a group of users or each device that is part of the group may be equal, in which case the MTD 110 is only a point of reference for the examples in these claims. The MTD 110 may limit identified MPDs to a proximate area. The proximate area may be determined based upon a specific distance from the location of the MTD 110, or based upon the effective radio range of the MTD 110. Alternatively, the MTD 110 may limit identified MPDs to the primary MPDs for members of the group. The MPD may be a text presentation device 140, such as a data terminal, desktop computer, or other device ideal for the presentation of text. The MPD may be a picture presentation device 150, such as a digital slide projector, adjustable picture display, or other device ideal for the presentation of pictures. The MPD may be an audio presentation device 160, such as a digital radio, stereo system or other device ideal for the presentation of audio. The MPD may be a video presentation device 170, such as a digital projector, high definition television (HDTV), or other device ideal for the presentation of video.

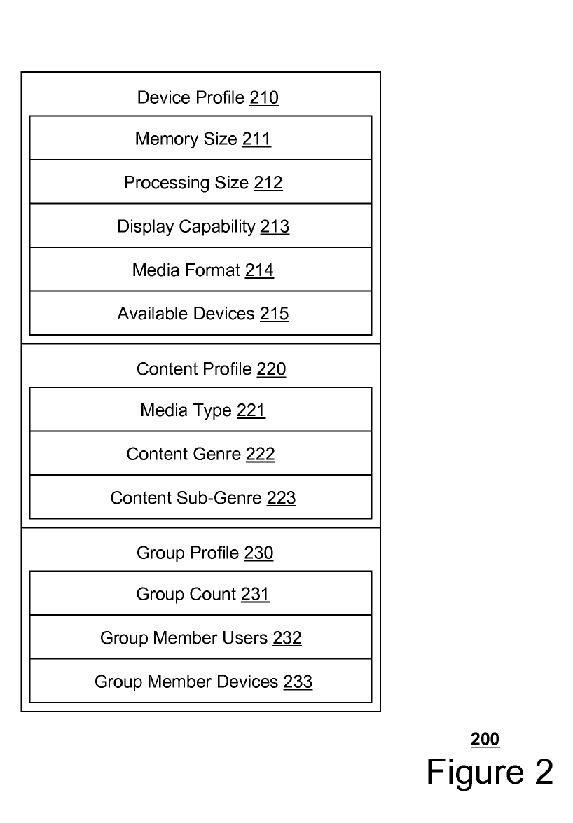

FIG. 2 illustrates in a block diagram a generic user profile 200 that may be used by a MTD 110 in selecting DMC. The user profile 200 may take a variety of forms, having greater or fewer fields than the ones shown in the generic profile. A user profile 200 may contain a number of profiles categorizing different aspects of the user's DMC habits. The user profile may have a device profile 210, a content profile 220, and a group profile 230.

The device profile 210 may be used in an MPD profile (MPDP) to describe the capabilities of the MPD. The device profile 210 may be used in a DMC profile (DMCP) to describe the device requirements of the DMC. Multiple device profiles 210 may be used in a personal media user profile (PMUP) or an associated individual media user profile (AIMUP) to describe MPDs available to that user or associated users. A PMUP and an AIMUP in this description refer to the same type of profile, but is used to differentiate between a first person and third person perspective.

The device profile 210 may have a memory storage field 211 describing the memory required by a set of DMC or the memory available in a MPD. The device profile 210 may have a processing size field 212 describing the processor size and speed required by a set of DMC or the processing size and speed available in a MPD. The device profile 210 may have a display capability field 213 describing the display capability required by a set of DMC or the display capability available in a MPD. The device profile 210 may have a media format field 214 describing the media format of a set of DMC or the media format supported by a MPD. In the media user profiles, the device profile 210 may have an available devices field 215 for listing devices available to that user.

The content profile 220 may be used to match a user preference to a specific DMC. The content profile 220 may be used in a DMCP to describe the content of the DMC. The content profile may be used in a PMUP or an AIMUP to describe MPDs available to that user or associated users. A content profile 220 may contain fields to track the many different kinds of digital media used by the MTD 110. The fields may take the form of matrices to appropriately represent the range of interests of a user. A content profile 220 may include a field 221 tracking the media types used by the MTD 110, such as text, audio, pictures, video, and other media types. A content profile 220 may include a field 222 tracking the content genre. Examples of genre may include music, spoken word, and others for audio; movies, television, and others for video; and novels, essays, and others for text. A content profile 220 may include a field 223 tracking the content sub-genres. Examples of sub-genres may include rock, country, rap, and others for audio; science fiction, mystery, thriller, biography, history, and religion for text; or action, comedy, drama, mystery, or animated for video.

The media user profiles may be combined to form a group media user profile (GMUP). The GMUP may include a group profile 230. The group profile 230 may contain a group count field 231 tracking the number of members in the group. The group profile 230 may contain a group member users field 232 tracking the members in the group. The group profile 230 may contain a group member devices field 233 tracking the devices available to the members in the group.

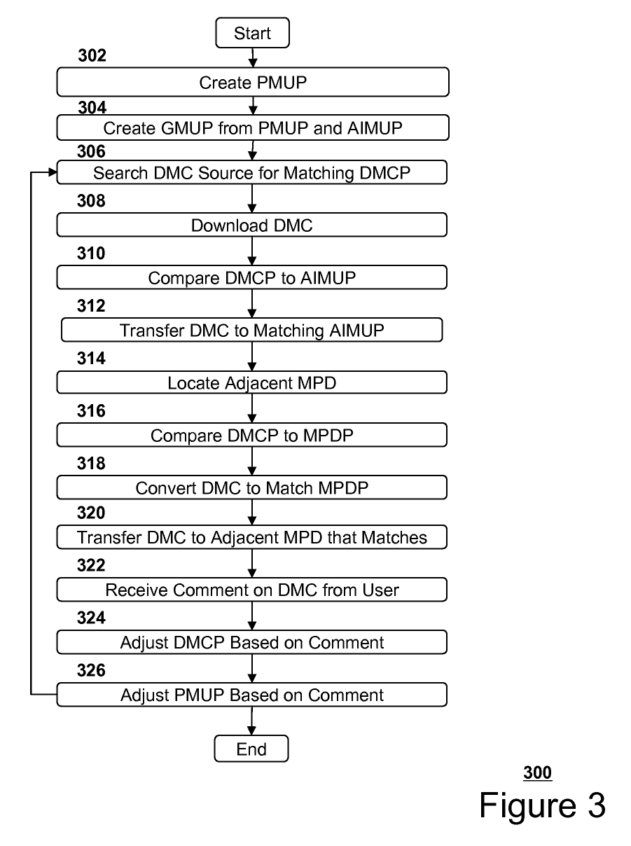

FIG. 3 illustrates in a flowchart one embodiment of a method 300 of using a GMUP to obtain DMC. A MTD 110 may create a PMUP (Block 302). The MTD 110 may create a GMUP by combining the PMUP with the AIMUPs of the other users of the group (Block 304). The MTD 110 may send a request to a DMC source 130 for a set of DMC with a DMCP that matches the GMUP (Block 306). The MTD 110 may download the matching DMC (Block 308). The MTD 110 may compare the DMCP to the AIMUPs to determine which associated users also would be interested in the content (Block 310). The MTD 110 may transfer the DMC to the users with a matching AIMUP (Block 312). The MTD 110 may locate any MPDs adjacent to the MTD 110 (Block 314). The adjacent MPDs may belong to users in the group or may be any new MPD within the vicinity of the MTD 110. The MTD 110 may compare the DMCP to the MPDP to determine the optimum device for presenting the DMC (Block 316). If no device is found that exactly matched the format of the DMC, the MTD 110 may convert the DMC to a format readable to the MPD that most closely matches the DMC (Block 318). If the conversion results in a degradation of the presentation of the DMC, the user may be notified that a higher quality version of the DMC is available. The MTD 110 may transfer the DMC to any matching MPD (Block 320). The MTD 110 may receive a comment from the user, or from other users in the group, on the DMC (Block 322). The comment may be a ranking, rating, or other judgment of the DMC. The MTD 110 may request the DMC source 130 to make an adjustment to the DMCP based upon the user's comment (Block 324). The MTD 110 may adjust the PMUP based upon the user's comment (Block 326).

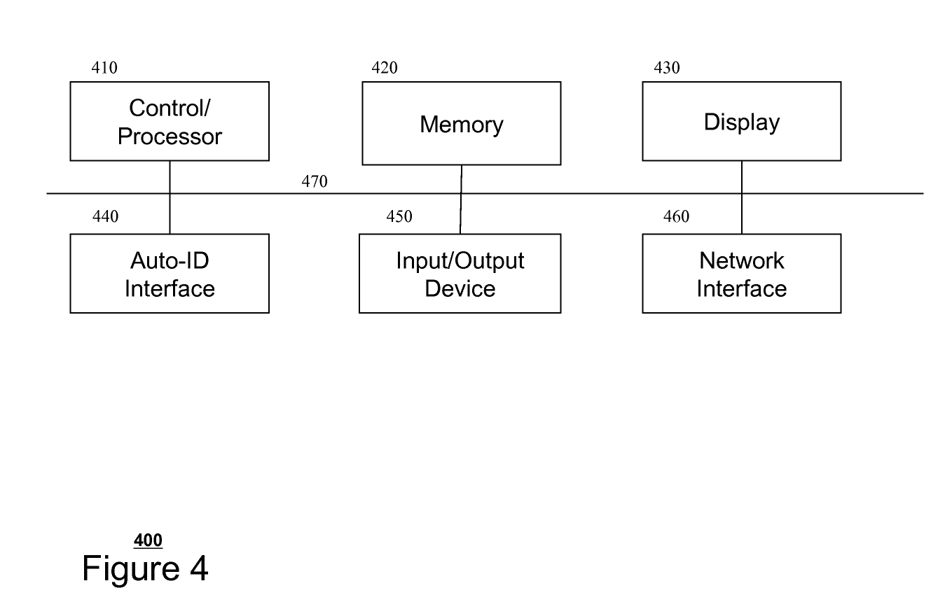

FIG. 4 illustrates a possible configuration of a computing system 400 to act as a mobile telecommunications apparatus or electronic device to execute the present invention. The computer system 400 may include a controller/processor 410, a memory 420, display 430, automatic identification (Auto-ID) interface 440, input/output device interface 450, and a network interface 460, connected through a bus 470. The computer system 400 may implement any operating system, such as Windows or UNIX, for example. Client and server software may be written in any programming language, such as ABAP, C, C++, Java, or Visual Basic, for example.

The controller/processor 410 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 420 may include volatile and nonvolatile data storage, including one or more electrical, magnetic or optical memories such as a random access memory (RAM), cache, hard drive, or other memory device. The memory may have a cache to speed access to specific data. The memory 420 may also be connected to a compact disc—read only memory (CD-ROM), digital video disc—read only memory (DVD-ROM), DVD read write input, tape drive, or other removable memory device that allows media content to be directly uploaded into the system.

The Auto-ID interface 440 allows the MTD 110 to connect to an Auto-ID network. The Auto-ID network allows the various MPDs to identify themselves to the MTD 110. One example of an Auto-ID network would be radio frequency identification (RFID) tags installed in the MPDs. This allows for a one-way communication link to be established from the MTD 110 to an MPD if necessary, as media content would just have to be sent from the MTD 110 to the MPD, but no communication would have to be sent from the MPD to the MTD 110 as the Auto-ID would have identified it.

The Input/Output interface 450 may be connected to one or more input devices that may include a keyboard, mouse, pen-operated touch screen or monitor, voice-recognition device, or any other device that accepts input. The Input/Output interface 450 may also be connected to one or more output devices, such as a monitor, printer, disk drive, speakers, or any other device provided to output data.

The network interface 460 may be connected to a communication device, modem, network interface card, a transceiver, or any other device capable of transmitting and receiving signals over a network. The network interface 460 may be used to transmit the media content to the selected media presentation device. The network interface may also be used to download the media content from a media source, such as a website or other media sources. The network interface 460 may also be used to communicate between the MTD 110 and the different proximate MPDs, allowing the MPDs to identify themselves to the MTD 110 if the MPD lacks an Auto-ID identifier or if the MTD 110 lacks an Auto-ID interface 440. The components of the computer system 400 may be connected via an electrical bus 470, for example, or linked wirelessly.

Client software and databases may be accessed by the controller/processor 410 from memory 420, and may include, for example, database applications, word processing applications, the client side of a client/server application such as a billing system, as well as components that embody the decision support functionality of the present invention. The user access data may be stored in either a database accessible through the database interface 440 or in the memory 420. The computer system 400 may implement any operating system, such as Windows or UNIX, for example. Client and server software may be written in any programming language, such as ABAP, C, C++, Java or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for optimizing a media presentation to a group, comprising:
creating a personal media user profile for a user of a mobile telecommunications device;
combining the personal media user profile with associated individual media user profiles to create a group media user profile; and
searching a digital media content source for a digital media content profile of a set of digital media content that matches the group media user profile.

2. The method of claim 1, further comprising:
comparing the digital media content profile to the associated individual media user profiles; and
distributing the set of digital media content to associated users with matching individual media user profiles.

3. The method of claim 1, further comprising:
receiving a comment on the set of digital media content from the user.

4. The method of claim 3, further comprising:
requesting an adjustment of the digital media content profile based on the comment.

5. The method of claim 3, further comprising:
adjusting the personal media user profile based on the comment.

6. The method of claim 1, further comprising:
locating an adjacent media presentation device.

7. The method of claim 6, further comprising:
comparing the digital media content profile to a media presentation device profile of the adjacent media presentation device; and
transferring the set of digital media content to the adjacent media presentation device if a match is found.

8. The method of claim 6, further comprising:
converting the set of digital media content to a format executable by the adjacent media presentation device.

9. A mobile telecommunications apparatus that optimizes a media presentation to a group, comprising:
a memory that stores a personal media user profile for a user;
a processor that creates a group media user profile from the personal media user profile and associated individual media user profiles; and
a network interface that sends a request to a digital media content source for a set of digital media content with a digital media content profile that matches the group media user profile.

10. The mobile telecommunications apparatus of claim 9, wherein the network interface distributes the set of digital media content to associated users with individual media user profiles matching the digital media content profile.

11. The mobile telecommunications apparatus of claim 9, further comprising:
a user interface that receives a comment on the set of digital media content from the user.

12. The mobile telecommunications apparatus of claim 11, wherein the processor adjusts the personal media user profile based on the comment.

13. The mobile telecommunications apparatus of claim 9, wherein the network interface distributes the set of digital media content to an adjacent media presentation device if the digital media content profile matches a media presentation device profile of the adjacent media presentation device.

14. The mobile telecommunications apparatus of claim 13, wherein the processor converts the set of digital media content to a format executable by the adjacent media presentation device.

15. An electronic device that optimizes a media presentation to a group, comprising:
a memory that stores a personal media user profile for a user;
a processor that creates a group media user profile from the personal media user profile and associated individual media user profiles; and
a network interface that sends a request to a digital media content source for a set of digital media content with a digital media content profile that matches the group media user profile.

16. The electronic device of claim 15, wherein the network interface distributes the set of digital media content to associated users with individual media user profiles matching the digital media content profile.

17. The electronic device of claim 15, further comprising:
a user interface that receives a comment on the set of digital media content from the user.

18. The electronic device of claim 17, wherein the processor adjusts the personal media user profile based on the comment.

19. The electronic device of claim 15, wherein the network interface distributes the set of digital media content to an adjacent media presentation device if the digital media content profile matches a media presentation device profile of the adjacent media presentation device.

20. The electronic device of claim 19, wherein the processor converts the set of digital media content to a format executable by the adjacent media presentation device.
